(19) United States
(12) Patent Application Publication
(10) Pub. No.: US 2010/0024181 A1
(43) Pub. Date: Feb. 4, 2010

(54) PROCESSES FOR FORMING BARIUM TITANATE CAPACITORS ON MICROSTRUCTURALLY STABLE METAL FOIL SUBSTRATES

(75) Inventors: Juan Carlos Figueroa, Wilmington, DE (US); Damien Francis Reardon, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. duPont de Nemours and Company, Wilmington, DE (US)

(21) Appl. No.: 12/183,281

(22) Filed: Jul. 31, 2008

(51) Int. Cl. H01G 4/08

(52) U.S. Cl. 29/25.42

(57) ABSTRACT

The present invention relates to a process for the manufacture of capacitors on metal foil using chemical solution deposition of a barium/titanium precursor formulation. The metal foil substrate is annealed and subsequently polished prior to the precursor formulation deposition in order to obtain a desirable process yield of capacitors without short circuits across the dielectric.

### FIELD OF THE INVENTION

The present invention relates to processes for making capacitors on metal foil substrates using chemical solution deposition of dielectric percursors. A metal foil substrate is annealed and subsequently polished prior to precursor deposition in order to obtain a desirable process yield of capacitors without short circuits across the dielectric.

### TECHNICAL BACKGROUND

Ko et al (US 2007/0081297) describe a method of manufacturing a thin film capacitor including the steps of: performing recrystallization heat treatment on a metal foil, forming a dielectric layer on a top surface of the recrystallized metal foil, heat treating the metal foil and the dielectric layer and forming an upper electrode on a top surface of the heat treated dielectric layer.

The present invention provides a process for the manufacture of capacitors, which includes a polishing step prior to depositing dielectric precursors onto a metal foil and subsequent to the recrystallization heat treatment of the metal foil.

### BRIEF DESCRIPTION OF THE DRAWINGS

FIG. 1 shows a flow diagram of a process according to one embodiment of the present invention.

FIG. 2 shows a schematic of a thin film capacitor on a metal foil.

### SUMMARY OF THE INVENTION

One aspect of the present invention is a process comprising:
a) providing a metal foil comprising grains;
b) annealing the metal foil to recrystallize the grains;
c) polishing the metal foil;
d) depositing a barium/titanium formulation film on the metal foil;
e) thermal processing the barium/titanium formulation film to form a barium titanate film; and
f) depositing an electrode onto the barium titanate film.

A further aspect of the present invention is a capacitor comprising:
a) a metal foil comprising a top surface and a bottom surface and cylindrical grains with boundaries that extend from the top surface to the bottom surface;
b) a barium titanate layer on the metal foil; and
c) at least one electrode on the barium titanate.

### DETAILED DESCRIPTION

The processes disclosed herein include a step of depositing a barium titanate dielectric thin film onto a metal foil. Deposition of barium titanate dielectric thin film onto a metal foil to make a thin film capacitor with high capacitance can be achieved through chemical solution deposition barium and titanium precursors, followed by controlled thermal processing.

For chemical solution deposition used in the processes disclosed herein, precursor molecules are deposited on the surface of a metal foil to form a barium/titanium formulation film. The precursor molecules are carried in a solvent and contain ligands chelated to barium and titanium and any acceptor or donor dopant constituent to be included in the barium titanate dielectric material. Appropriate barium and titanium (IV) precursors are of the type

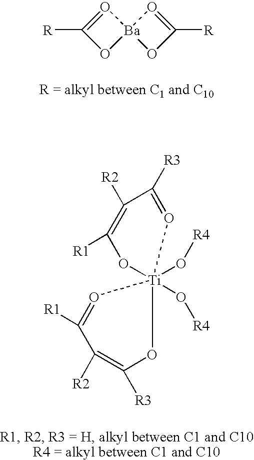

Suitable solvents for the deposition of the precursors include alcohols, carboxylic acids, and mixtures of alcohols and carboxylic acids.

A capacitor is a device that can store an electric charge that is directly proportional to its capacitance value. In an AC circuit, the current and voltage across an ideal capacitor are 90° out of phase; in practice, however, in a real capacitor a fraction of the current across it will not be 90° out of phase, and the tangent of the angle by which the current is out of phase from ideal is called the “loss tangent” or “dissipation factor”. The insulation resistance of the dielectric is a measure of its ability to withstand leakage of current under a DC potential gradient.

A process used for the determination of capacitance density and dissipation factor is outlined below. The measurements were made on a circuit containing the capacitor, a power supply for DC and AC bias, an ammeter and a volt meter.
1) The initial capacitance and dissipation factor measurement was made with a 0 V DC bias, 50 mV AC bias, and a frequency of 1 kHz
2) A second capacitance and dissipation factor measurement was made with a 1.3 V DC bias, 50 mV AC bias, and a frequency of 1 kHz
3) A DC Bias sweep was made in both the positive and negative directions. One measurement was taken at each of the following conditions:

Positive Bias sweep 0 to 10V DC
a) 0 V DC bias; 50 mV AC bias, frequency=1 kHz
b) 1 V DC bias; 50 mV AC bias, frequency=1 kHz
c) 2 V DC bias; 50 mV AC bias, frequency=1 kHz
d) 3 V DC bias; 50 mV AC bias, frequency=1 kHz
e) 4 V DC bias; 50 mV AC bias, frequency=1 kHz
f) 5 V DC bias; 50 mV AC bias, frequency=1 kHz
g) 6 V DC bias; 50 mV AC bias, frequency=1 kHz
h) 7 V DC bias; 50 mV AC bias, frequency=1 kHz
i) 8 V DC bias; 50 mV AC bias, frequency=1 kHz
j) 9 V DC bias; 50 mV AC bias, frequency=1 kHz
k) 10 V DC bias; 50 mV AC bias, frequency=1 kHz
l) 9 V DC bias; 50 mV AC bias, frequency=1 kHz
m) 8 V DC bias; 50 mV AC bias, frequency=1 kHz
n) 7 V DC bias; 50 mV AC bias, frequency=1 kHz
o) 6 V DC bias; 50 mV AC bias, frequency=1 kHz
p) 5 V DC bias; 50 mV AC bias, frequency=1 kHz
q) 4 V DC bias; 50 mV AC bias, frequency=1 kHz
r) 3 V DC bias; 50 mV AC bias, frequency=1 kHz
s) 2 V DC bias; 50 mV AC bias, frequency=1 kHz
t) 1 V DC bias; 50 mV AC bias, frequency=1 kHz
u) 0 V DC bias; 50 mV AC bias, frequency=1 kHz

Negative Bias sweep 0 to −10V DC
a) 0 V DC bias; 50 mV AC bias, frequency=1 kHz
b) −1 V DC bias; 50 mV AC bias, frequency=1 kHz
c) −2 V DC bias; 50 mV AC bias, frequency=1 kHz
d) −3 V DC bias; 50 mV AC bias, frequency=1 kHz
e) −4 V DC bias; 50 mV AC bias, frequency=1 kHz
f) −5 V DC bias; 50 mV AC bias, frequency=1 kHz
g) −6 V DC bias; 50 mV AC bias, frequency=1 kHz
h) −7 V DC bias; 50 mV AC bias, frequency=1 kHz
i) −8 V DC bias; 50 mV AC bias, frequency=1 kHz
j) −9 V DC bias; 50 mV AC bias, frequency=1 kHz
k) −10 V DC bias; 50 mV AC bias, frequency=1 kHz
l) −9 V DC bias; 50 mV AC bias, frequency=1 kHz
m) −8 V DC bias; 50 mV AC bias, frequency=1 kHz
n) −7 V DC bias; 50 mV AC bias, frequency=1 kHz
o) −6 V DC bias; 50 mV AC bias, frequency=1 kHz
p) −5 V DC bias; 50 mV AC bias, frequency=1 kHz
q) −4 V DC bias; 50 mV AC bias, frequency=1 kHz
r) −3 V DC bias; 50 mV AC bias, frequency=1 kHz
s) −2 V DC bias; 50 mV AC bias, frequency=1 kHz
t) −1 V DC bias; 50 mV AC bias, frequency=1 kHz
u) 0 V DC bias; 50 mV AC bias, frequency=1 kHz
4) One final capacitance and dissipation factor measurement was made at a 1.3 V DC bias, 50 mV AC bias, and a frequency of 1 kHz.

The determination of the DC insulation resistance was made with a circuit containing the capacitor, a reference resistor, a DC power supply, a voltmeter and an ammeter. A 2 V DC bias potential was imposed on the capacitor, and the leakage DC current was measured at 5, 25 and 120 seconds after voltage application.

A “hard shorted” capacitor, as used herein means a capacitor having at any of the measurement steps described above:
i) a capacitance density less than 0.001 μF/cm², or
ii) a dissipation factor bigger than 30,000, or
iii) a DC resistance of zero Ohms.

Process yield, as used herein, is defined as the percent number of non hard-shorted capacitors within a total population of tested capacitors that were fabricated under identical process conditions. It is found that the process yield of capacitors without short circuits across the dielectric is significantly improved when a metal foil substrate is prepared by annealing and polishing prior to precursor deposition. In the processes disclosed herein, a process yield of 80% or more is highly preferred, 60% or more is preferred and 30% or more is desirable.

Metal foils are purchased in a soft temper condition resulting from heat treatments that reduce the hardness of cold rolled foils. Thin film capacitors manufactured via the chemical solution deposition of a dielectric precursor formulation on a metal foil substrate electrode are fired at high temperature to sinter and densify the dielectric layer. During the firing, microstructural instability of the metal foil substrate may detrimentally impact the yield of the process. Giving the metal foil a recrystallization anneal and subsequently polishing the metal foil prior to dielectric precursor deposition improves the microstructural stability and the process yield.

Solvent is used in the process, as a carrier medium to deposit uniformly the precursors on the surface of the foil. The combination of titanium and barium precursors often leads to precipitation of either one of the precursors or to both simultaneously. This can have a cascade effect on the properties of the dielectric, since a 1:1 ratio between Ba and Ti is the ideal stoichiometry. Preferred concentration of the precursor in the solvent is from 0.5M to 0.3M. Too high or low a concentration can lead to cracking and/or porosity of the film.

To obtain a uniform coating of the barium/titanium ormulation film on the metal foil, the surface of the foil is prepared to increase wetting of the surface, maximize performance of the final capacitor device and increase the yield of the process.

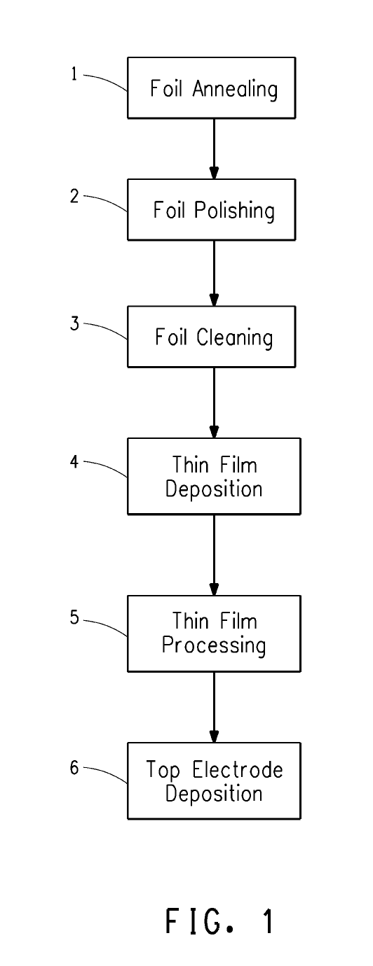

The flow chart in FIG. 1 illustrates one embodiment of a process of the present invention. This illustrated embodiment uses a metal foil such as a nickel or copper foil. Prior to annealing, the metal foil is cleaned with water, then an organic solvent such as 2-propanol, then a second organic solvent such as acetone. Box 1 of the flow chart illustrates a process by which the metal foil is annealed to recrystallize the metal grains at partial pressures of oxygen low enough to inhibit macroscopic oxidation. When the metal foil is nickel, a oxygen partial pressure of less than 10⁻¹⁵ atm is used to recrystallize the metal grains without further oxidation.

After the recrystallization anneal of the metal foil, the most preferred grain structure comprises cylindrical grains of diameter between 0.8 and 2 times the thickness of the foil. These cylindrical grains generally extend from the top surface of the metal foil to the bottom surface of the metal foil. This microstructure has a structural stability that is increased relative to equiaxed grains because the thermally induced mobility of the cylindrical grain boundaries is reduced. Additionally, deleterious effects of grain boundaries that intersect the foil surface on the formation of a dielectric coating via the chemical solution deposition process are minimized because the grain boundary length per unit of foil surface area is substantially reduced when cylindrical grains are formed. The annealing time and temperature, that facilitate the formation of cylindrical grains, are described below for foils having a Ni 201 composition, purchased in the cold rolled and/or soft annealed state from, for example, All Foils Inc. of Cleveland, Ohio and with a thickness equal or below to 75 microns. At 1,200° C., a minimum of 5 minutes is preferred. At 1,100° C., a minimum of 10 minutes is preferred. At 1,000° C., a minimum of 15 minutes is preferred. Foil thicknesses up to 500 microns can be used but the recrystallization anneal conditions may be varied.

Box 2 of the flowchart in FIG. 1 represents the process by which the annealed foil is polished to a roughness of less than 50 nm for a sampling length of 72 μm by optical profilometry. Polishing can be mechanical, chemical, chemical-mechanical or electrochemical. Finally, the metal surface is cleaned through a solvent process by a series of washing steps with water, an organic solvent such as 2-propanol and a second organic solvent such as acetone as represented by Box 3

Box 4 of FIG. 1 represents multiple steps which include the deposition of the barium/titanium formulation film. The precursor formulation containing both Ba/Ti precursor molecules and the solvent can be applied to the metal foil by any known coating technique such as spray-coating, spin-coating, immersion, brushing doctor blades.

The process by which a precursor thin film comprising organic ligands is processed to a barium titanate thin film is described below and is represented in FIG. 1 by Box 5. Once the solution is coated on the foil, the solvent is removed by evaporation. This can be done by heating at temperatures of about 100° C. for a few minutes, e.g, from about 1 to about 60 minutes. Following the removal of the solvent from the deposited film, the organic ligands chelating the barium and titanium precursors are decomposed and/or removed. This procedure is done by heating the coated metal substrate. For nickel foils, temperatures between 250° C. to 400° C. for a time period (between 1 and 60 min) are used which result in a deposit of decomposed precursor without oxidation of the nickel foil. The resulting deposit is amorphous barium titanate or an amorphous inorganic precursor to barium titanate, which may be doped with other constituents such as strontium, with Group II, Group III, transition metals or rare earths to achieve the desired dielectric properties and leakage current of the crystalline barium titanate.

Exposure of the nickel foil to temperatures above 400° C. for extended periods of time in air would lead to oxidation of the nickel. The resulting NiO formation would yield lower capacitance values. It is desirable that the capacitance density be higher than 1 μF/cm². The transformation of the amorphous doped or non-doped barium titanate to the crystalline state on nickel foil requires heating to higher temperatures under low partial pressure of oxygen as part of the firing step. It is found that heating the amorphous barium titanate to temperatures >550° C. under an atmosphere with a oxygen partial pressure of 10⁻⁸ or less reduces the oxidation of the nickel foil for heating periods between 10 s and 5 hours which is long enough to crystallize the barium titanate. However, heating the barium titanate in oxygen partial pressures less than 10⁻¹⁰ atmospheres introduces defects into the barium titanate which increase the leakage current of the dielectric. The leakage current could be reduced by a reoxygenation heat treatment. However this requires an extra process step. An example of crystallization heat treatment conditions wherein the reoxygenation treatment can be omitted is in an atmosphere between 10⁻⁸ and 10⁻¹⁰ atmospheres of oxygen at 750° C. or above for 1 to 60 minutes. Multiple layer deposition, drying, pre-firing and firing steps for one or multiple layer of the dielectric also provides a clean removal of the organic material from the dielectric and yields a dense film with low porosity and low organic impurities.

Generally, in a process of the present invention, the metal foil substrate (such as copper, nickel, silver, gold or platinum and alloys containing these metals) is used as a first electrode. After the barium titanate or doped barium titanate dielectric is crystallized, a second electrode can be deposited on the dielectric (Box 6 of FIG. 1). The second electrode is a conductor and may be copper, nickel, silver, gold or platinum. The second electrode may be sputtered or vapor deposited.

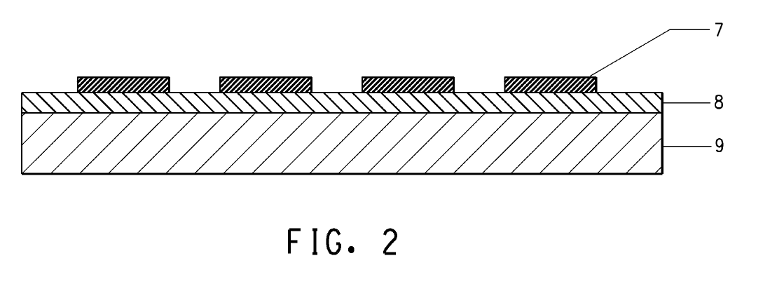

FIG. 2 shows a device formed by a process according to an embodiment of the present invention. The figure illustrates a thin film barium titanate dielectric layer that has been deposited in n layers and is sandwiched between two electrodes which on one side is a metal foil (e.g, Ni foil substrate) and on the other is a vapor deposited metal electrode. In FIG. 2, the vapor deposited metal electrode (top electrode) is represented by 7, the barium titanate layer by 8 and the metal substrate (bottom electrode) by 9. The complete structure represents the thin film capacitor device as a result of the process

### EXAMPLE

In the following example, a precursor 0.2 M formulation with respect to [Ti] was prepared as follows. 25.5100 g (89.99 mmol) of anhydrous barium propionate was dissolved in a minimum amount of propionic acid (60.00 ml). To this solution, was added 35.3100 g of bis(acetylacetonato)bis(butoxo)titanium (89.99 moles). The solution was stirred and 1-butanol was added until the total volume of 600.00 mL was achieved.

In an alternate process, the precursor was made as follows. 34.035 g of titanium tetra butoxide (99.9%, Acros) was weighed into a 100 ml bottle inside the drybox. 20.024 g of purified 2,4-pentadione (Aldrich) was added and the mixture was stirred for a 5 minutes. The bottle was sealed and removed from the drybox. 31.548 g of barium hydroxide hydrate (99.995% Aldrich) was added to a 500 ml volumetric flask. About 200 ml of 50/50 mixture of propionic acid/1-butanol was added and stirred for 1 minute. The titanium bis(acetylacetonato)bis(n-butoxo) mixture was then added from the sealed bottle. The bottle was rinsed with a 50/50 mixture of propionic acid/1-butanol solution into the 500 ml volumetric containing the barium hydroxide three times. The 50/50 mixture of propionic acid/1-butanol was then added up to the mark on the flask. A stir bar was then placed into the flask and the solution was left to stir until all solids were dissolved.

### Example 1

Four 2″×2″×0.0016″ Ni foils having a bright surface finish (surface roughness RMS=40−70 nm) were annealed at 1,000° C. for 30 minutes in a tube furnace having a partial pressure of oxygen of 1·10⁻¹⁷ atm. Such annealing treatment yielded a foil metallurgical structure whereby at least 80% of the grains were cylindrical with a base diameter between 0.8 and 2.0 times the foil thickness. The foils were then abrasively polished at 0.72 m/min with a contact pressure of 3.4 psi using a colloidal silica suspension for a period of 24 hours.

The foils were cleaned prior to spin coating, first with water, then 2-propanol, then acetone. The spin coating conditions were: 750 μL/sublayer, 2000 rpm/30 secs, 10 sublayers. After spin coating of each precursor sublayer, the precursor sublayers were calcined at 150° C./5 min, then 400° C./15 min.

After all ten sublayers were deposited and calcined, one final fire to crystallize the BT layer was executed at 850° C. for 30 minutes, using infra red lamp heaters in a stainless steel chamber cryo-pumped @ 1 mTorr of Ar flowing @ 18 sccm. The partial pressure of oxygen during firing, as determined by a residual gas analyzer, was 4×10⁻⁹ atm.

Copper top electrodes were vapor deposited onto the dielectric surface using a contact mask having twenty five 3 mm×3 mm square holes. The capacitors were then tested at room temperature for capacitance, loss tangent and insulation resistance.

In this case, upon testing of dielectric performance fifty nine out of one hundred capacitors shorted, resulting in 41% yield.

Concentrations between 0.05M and 0.3M have been tried and have been used in conjunction with the current process. This does not exclude the possibility that other concentrations could be used with other processing conditions.

### Comparative Example 1

In this Comparative Example, the samples were not annealed or polished. Four 2″×2″×0.0016″ Ni foils having a bright surface finish (surface roughness RMS=40-70 nm) were cleaned prior to spin coating with water, then 2-propanol, then acetone. The spin coating conditions were: 750 μL/sublayer, 2000 rpm/30 secs, 10 sublayers. After spin coating of each precursor sublayer, the precursor sublayers were calcined at 150° C./5 min, then 400° C./15 mins.

After all ten sublayers were deposited and calcined, one final fire to crystallize the BT layer was executed at 850° C. for 30 minutes, using infra red lamp heaters in a stainless steel chamber cryo-pumped @ 1 mTorr of Ar flowing @ 18 sccm. The partial pressure of oxygen during firing, as determined by a residual gas analyzer, was 4·10⁻⁹ atm.

Copper top electrodes were vapor deposited onto the dielectric surface using a contact mask having an array of twenty five square openings.

The capacitors were then tested at room temperature for capacitance, loss tangent and insulation resistance. Upon testing of dielectric performance all one hundred capacitors shorted resulting in 0% yield.

What is claimed is:

1. A process comprising:
a) providing a metal foil comprising grains;
b) annealing the metal foil to recrystallize the grains;
c) polishing the metal foil;
d) depositing a barium/titanium formulation film on the metal foil;
e) processing the barium/titanium formulation film to form a barium titanate film; and
f) depositing at least one electrode on the barium titanate film.

2. The process of claim 1 wherein the metal foil is selected from the group consisting of nickel, copper, gold, silver, platinum and alloys containing nickel, copper, gold, silver, and platinum.

3. The process of claim 1 wherein the metal foil has a thickness less than 500 microns.

4. The process of claim 1 wherein the metal foil is nickel and the annealing is at 1200 C for at least 5 minutes.

5. The process of claim 1 wherein the metal foil is nickel and the annealing is at 1100 C for at least 10 minutes.

6. The process of claim 1 wherein the metal foil is nickel and the annealing is at 1000 C for at least 15 minutes.

7. The process of claim 1 wherein the polishing is mechanical.

8. The process of claim 1 wherein the polishing is chemical.

9. The process of claim 1 wherein the polishing is electrochemical.

10. The process of claim 1 wherein the polishing is chemical-mechanical

11. The process of claim 1 wherein the at least one electrode on the barium titanate film is nickel, copper, gold, silver, platinum and alloys containing nickel, copper, gold, silver, and platinum

12. A capacitor comprising:
a) a metal foil comprising a top surface and a bottom surface and cylindrical grains with boundaries that extend from the top surface to the bottom surface;
b) a barium titanate layer on the metal foil, and
c) at least one electrode on the barium titanate;

13. The capacitor of claim 12 wherein the metal foil is selected from the group consisting of nickel, copper, gold, silver, platinum, and alloys containing nickel, copper, gold, silver, and platinum.

14. The capacitor of claim 12 wherein the metal foil has a thickness less than 500 microns

15. The capacitor of claim 12 wherein the at least one electrode on the barium titanate is nickel, copper, gold, silver, platinum, and alloys containing nickel, copper, gold, silver, and platinum
